(19) United States
(12) Patent Application Publication
(10) Pub. No.: US 2015/0142727 A1
(43) Pub. Date: May 21, 2015

(54) ANALYTIC OPERATIONS FOR DATA SERVICES

(71) Applicant: salesforce.com, inc., San Francisco, CA (US)

(72) Inventors: Patrick Yu Pang Louie, San Francisco, CA (US); Arunkumaran Varadharajan, San Francisco, CA (US); Daniel Scott Perry, New Westminster (CA); Aditya Kochhar, Redwood City, CA (US); Jan Michael Timmerman, Vancouver (CA); Paul James McArthur, Mission (CA); Santanu Sinha, Fremont, CA (US); Smita S. Kulkarni, San Ramon, CA (US); Sushanth Ramakrishna, San Francisco, CA (US); Twisha Mehta, Fremont, CA (US)

(21) Appl. No.: 14/547,080

(22) Filed: Nov. 18, 2014

Related U.S. Application Data
(60) Provisional application No. 61/905,649, filed on Nov. 18, 2013.
(60) Provisional application No. 61/905,655, filed on Nov. 18, 2013.
(60) Provisional application No. 61/905,910, filed on Nov. 19, 2013.

(51) Int. Cl. G06F 17/30

(52) U.S. Cl. CPC G06F 17/30554; G06F 17/30589
USPC 707/603

(57) ABSTRACT

Embodiments regard analytic operations for data services. An embodiment of a method includes: receiving a request at a database system from a user to embed a representation of analytics data on a first page generating by a processing unit of the database system an embed area in the page in which to display the analytics data on the page; storing in a memory of the database system metadata associated with the page describing the embed area; and upon the database system detecting an access to the first page, generating by the database system the first page with the analytics data located in the embed area based upon the metadata.

### CROSS REFERENCE TO RELATED APPLICATIONS

This United States patent application is related to, and claims priority to U.S. Provisional Patent Application No. 61/905,649 filed Nov. 18, 2013, entitled “Embedded Analytics,” and having Attorney Docket No. 1368PROV, U.S. Provisional Patent Application No. 61/905,655 filed Nov. 18, 2013, entitled “Result Sets,” and having Attorney Docket No. 1369PROV, and U.S. Provisional Patent Application No. 61/905,910 filed Nov. 19, 2013, entitled “Analytics Platform,” and having Attorney Docket No. 1371PROV, the entire contents of which are incorporated herein by reference.

### TECHNICAL FIELD

Embodiments relate to techniques for data services. More particularly, embodiments relate to analytic operations for data services.

### BACKGROUND

In a database system containing a great amount, the analysis of data allows users to make sense of the data. For example, there may be many reports available for the user that provide useful views of the data.

However, in conventional systems, for a user to view analytics data, the user is required to leave the current record page and switch to a different page, such as via switching to a Reports tab. For this reason, a user is often required to switch back and forth between screens to take advantage of analytical functions of the system, but requiring more user time and making it more difficult for a user to understand the data in the context of the analysis.

### BRIEF DESCRIPTION OF THE DRAWINGS

Embodiments are illustrated by way of example, and not by way of limitation, in the figures of the accompanying drawings in which like reference numerals refer to similar elements.

FIG. 1 is an illustration of a system for providing embedded analytics according to an embodiment;

FIG. 2 is an illustration of a record containing an embedded report according to an embodiment;

FIG. 3 is a flowchart to illustrate embedding analytics data on a page;

FIG. 4 is a flowchart to illustrate data analytics including data from multiple data stores according to an embodiment;

FIG. 5 illustrates a block diagram of an environment; and

FIG. 6 illustrates details of an environment according to an embodiment.

### DETAILED DESCRIPTION

In the following description, numerous specific details are set forth. However, embodiments may be practiced without these specific details. In other instances, well-known circuits, structures and techniques have not been shown in detail in order not to obscure the understanding of this description.

In some embodiments, a process, apparatus, or system provides embedded analytics for data services. In some embodiments tools and techniques allow a user to obtain analytics data the user requires on a page, without being required to switch to a reports page, such as by accessing a Reports tab or other similar action.

In one implementation, a process, apparatus, or system enables the embedding of report charts directly into record pages themselves without additional programming. For example, a user requests the embedding of a chart or other analytics data directly in the record detail pages for any standard or custom object. The user may provide the request by, for example, dragging and dropping the report, chart, or other visualization of the analytics data directly onto the page itself. In this way, users are enabled to make decisions based not only on the standard fields displayed on a page, but further based on the analytics data the users see in the context of the page.

In some embodiments, a process includes receiving input from a user to embed a representation of analytics data on a page; generating an embed area in which to display the analytics data on the page; storing metadata associated with the page describing the embed area; and generating the page with the analytics data located in the embed area upon access by the user.

In some embodiments, a process, apparatus, or system provides for an analytics platform for a user. In some embodiments, the analytics platform includes operation of a database system and access to an Analytics API (Application Programming Interface) by a user. In some embodiments, the Analytics API allows a user to integrate data into, for example, web or mobile applications.

In some embodiments, a process, apparatus, or system provides for result sets that may be run synchronously or asynchronously. In some embodiments, result set data may be embedded in a page. In contrast, in a conventional system, a report may be limited to running synchronously and the result may be received at that time. If this was not done in the conventional system, the metadata may shift between the run and the results. In some embodiments, a report may be run asynchronously, with report being serialized to binary. In this manner there is a save of the results and metadata. In some embodiments, when the report is loaded, there is a check that is performed to compare the metadata. If there is no match of the metadata, then the results are not valid and are not shown.

In some embodiments, a report may be run that reflects the data changes utilizing saved results and metadata to ensure the data is up to date. In some embodiments, a user also may view previous snapshots of data, such as, for example, a snapshot of sales figures at a previous time.

In some embodiments, a process, apparatus, or system enables a user to set alerts on data to provide notification when there are certain changes in the data. In some embodiments, a process, apparatus, or system enables a user to retrieve data from multiple data stores and display such data in the form of data from a single data store or as coming from different data stores.

In some embodiments, a process includes retrieving data to be analyzed from a first data store; retrieving data to be analyzed from a second data store; generating combined data from the first data store and the second data store; and displaying the combined data to a user.

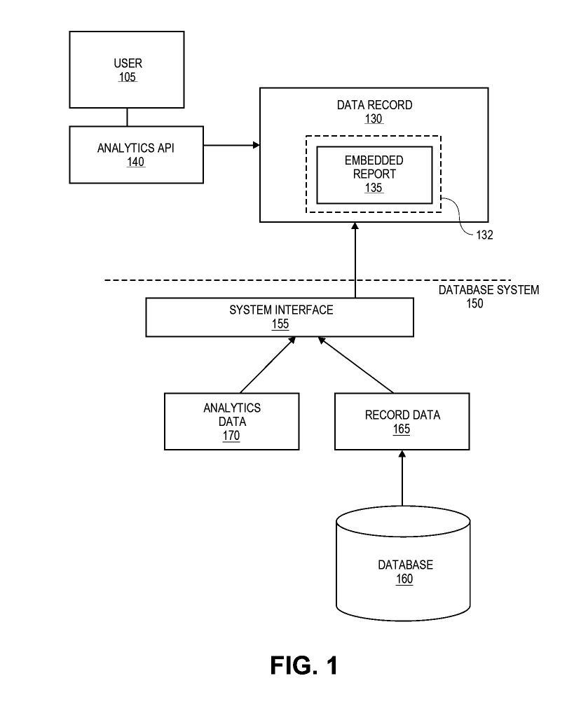

FIG. 1 is an illustration of a system for providing embedded analytics according to an embodiment. In some embodiments, a user 105 may access an Analytics API 140 to request the embedding of a report 135 in a data record 130 (which may be referred to as a page) from a database system 150 with a system interface 155.

In some embodiments, a process includes generating by the system 150 an embed area 132 in which to display analytics data on the page in response to the request and storing metadata associated with the page describing the embed area.

In some embodiments, the process further includes generating the data record with the analytics data for the embedded report 135 located in the embed area 132 upon access by the user or another party, wherein the generation of the page may include retrieval of analytics data 170 together with record data 165 from a database 160.

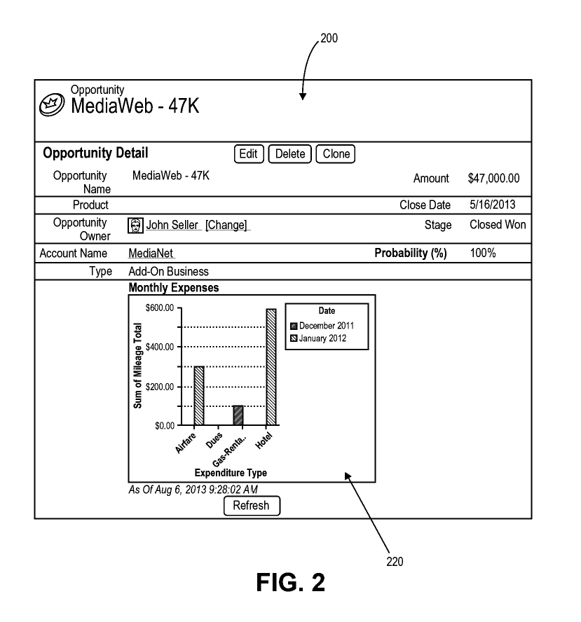

FIG. 2 is an illustration of a record containing an embedded report according to an embodiment. In this example, an opportunity record 200, which is record for a particular sales opportunity with account name MediaNet and opportunity holder John Seller for an amount of $47,000 and a closing date of May 16, 2013. In some embodiments, the detail page 200 for the opportunity detail includes an embedded report, the report including a sum of monthly expenses for certain expenditure types. In some embodiments, the embedded report is operable to illustrate key data directly on the detail page in the embedded report 220 in an embed area upon access to the detail page 200.

In some embodiments, adding a report chart to a Page Layout involves embedding the report chart on standard or custom object pages. In some embodiments, a user may edit the object's page layout with an enhanced page layout editor, and then add the chart. In some embodiments, a chart can be dragged and dropped to the page layout. In other implementations, the user may be prompted to create a new field, area, box, or other area in which to place the new chart. In some embodiments, an Analytics API may be utilized by a user to embed analytics data in a record.

In some embodiments, a user can embed more than one report chart on a page. For example, a user may want to include two report charts on an important account page that show information such as deals in the pipeline and open support cases for the account. From the information providing in the charts, the account executive can, for example, quickly gauge the account's activity and health.

In some embodiments, in order to facilitate embedded analytics, an Analytics API enables a user to request that calls to analytics data be made and that the analytics data provided in a generated chart on a page. In this particular example, the calls are defined with API Report Builder, which results in the generation of a particular chart. In one implementation, the calls to analytics data can be made through a REST (Representational State Transfer) based API for easy integration in HTML5 Apps. However, embodiments are not limited to a particular type of API. In addition, the data itself may be put into JSON (JavaScript Object Notation) serialization format, which is simple to integrate with charting libraries.

In some embodiments, an Analytics API may be used both in synchronous and asynchronous modes of operation. In one implementation, the Analytics API supports dynamic filtering, allowing a user to modify report filters at runtime and re-use the same report in different contexts.

In some embodiments, embedded analytics may utilize a page layout editor to provide for the embedding of analytics into a page. In some embodiments, the embedding of analytics data into the page may include dragging and dropping visualizations of analytics, wherein the analytics may be embedded in any standard page to provide contextual and interactive information.

In some embodiments, a system that is operable to provide analytic operations for data services including the embedding of analytics into pages further includes a change notification system to inform users when the underlying data for embedded analytics has changed and the associated chart or report has been updated. In some embodiments, an API includes the capability of defining certain change conditions or thresholds, wherein the detection of a defined change results in the generation of a change notification, such as sent via email or a Salesforce Chatter account or by triggering the performance of certain tasks.

In some embodiments, a change notification can include, for example, a complete reposting of the chart with the new or updated information, or the posting of a delta (an indication of changed information) in the chart. This may be particularly relevant if, for example, the analytics chart includes animated or dynamically rendered information. In some embodiments, the change notification may be posted to the user's Salesforce Chatter feed, email, text, home page, or any other similar location where the user can receive the change notification. In one implementation, the user can personalize or customize the change notification system, such as to allow the user to modify the manner in which the change notification is provided, the conditions under which a change notification is triggered, or other aspects of the change notification system. In one implementation, the user can create tasks or perform other actions based on the analytics notification.

In some embodiments, existing charts may be reused to provide embedded analytics in multiple locations on different pages. In this manner, generated chart may be repurposed to be initiated when a page is accessed, thereby allowing a user to utilize prior efforts in generating an embedded chart.

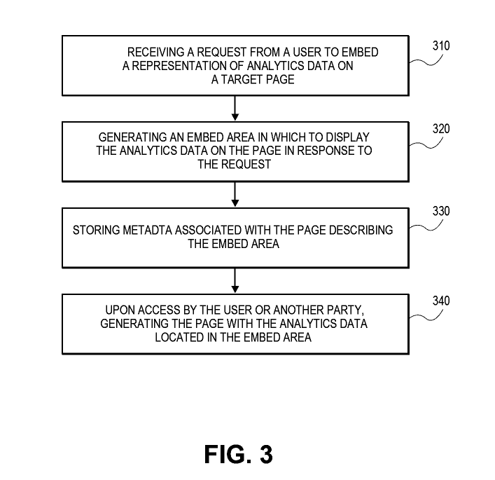

FIG. 3 is a flowchart to illustrate embedding analytics data on a page. In some embodiments, a method for embedding analytics includes receiving at a system a request from a user to embed a representation of analytics data on a particular page (which may be referred to as a target page) 310. In some embodiments, the user may provide the request through an Analytics API. In some embodiments, the process includes generating by the system an embed area in which to display the analytics data on the target page in response to the request 320, and storing metadata associated with the target page describing the embed area 330. In some embodiments, the process includes generating the page with the analytics data, such as in a chart, located in the embed area upon access by the user 340.

In some embodiments, a method includes receiving a request at a database system from a user to embed a representation of analytics data on a first page; generating by a processing unit of the database system an embed area in the page in which to display the analytics data on the page; storing in a memory of the database system metadata associated with the page describing the embed area; and upon the database system detecting an access to the first page, generating by the database system the first page with the analytics data located in the embed area based upon the metadata.

Analytics can be an effective way to, for example, improve sales performance. An Analytics API allows users to generate analytics reports, charts and other data, including the embedding of such data in a particular page or pages. In some embodiments, a user can include analytics data (either as pure data or in a visual form) on any page in a system, including, for example, the Salesforce.com system. The data system is operable to assist in this operation by allowing the user to make REST-based calls to the underlying data and using JSON or other similar technology to rapidly serialize the data to be displayed on a page. In some embodiments, the rendering of the analytics data on a page can be either synchronous or asynchronous depending on a variety of factors such as how much data is being rendered, the accessibility of the data in cache, and other resource constraints.

In some embodiments, the data system and associated Analytics APIs allow users a powerful means to navigate information. For example, in a CRM (Customer Relationship Management) embodiment, a manager may utilize the Analytics API to generate reports, charts or other data that assist the manager and members of a team to navigate the team's deals.

In some embodiments, the data system and Analytics APIs further enable a user to set alerts with regard to analytics data. For example, a sales manager may utilize an Analytics API to set alerts such that when members of the manager's team close a deal, the manager then receives a notice or alert. In some embodiments, the notice or alert may be provided through email, Salesforce Chatter, text message, or other message delivery service. In an example, a Chatter based solution combines data from Salesforce reports to monitor certain established thresholds, and, upon a threshold being met or exceeded, posting a message to the appropriate Chatter account or accounts.

In some embodiments, a data system and one or more APIs enable a user to retrieve data from not only a single data store, such as, for example, the Salesforce.com platform, but from other databases and/or data repositories as well. In some embodiments, the system is operable to display data from the different sources in a same analytics chart in the same or similar manner as if the data was derived from a single source, thereby providing information from multiple sources in a combined visualization. Alternatively, a data system and one or more APIs can operate to display charts and analytics information retrieving data from multiple data stores in order to indicate the different stores from which the data is derived.

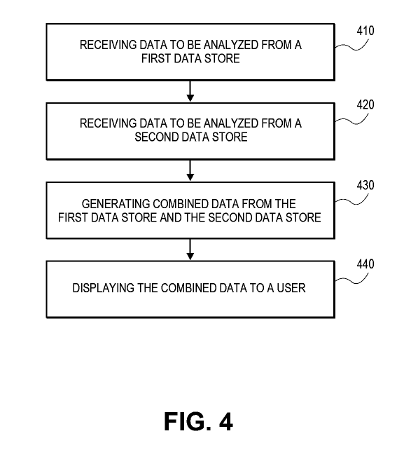

FIG. 4 is a flowchart to illustrate data analytics including data from multiple data stores according to an embodiment. In some embodiments, a process for data analytics includes retrieving data to be analyzed from a first data store 410; retrieving data to be analyzed from a second data store 420; generating combined data based on the data from the first data store and the second data store 430; and displaying the combined data to a user 440, wherein the display of the data may optionally be display in a same manner as data derived from a single data store or separately to indicate the separate sources of information. In some embodiments, analytics may include generation of a page with embedded analytics data, such as element 340 of FIG. 3.

In some embodiments, a method includes receiving a request to generate an analytics report through an analytics API for a database system; and in response to the request, rendering by a processing unit of the database system analytics data for display on a page, including establishing calls to underlying data stored in a data store for the analytics report, and serializing the analytics data for display on a page, wherein rendering of the data by the database system may utilize either synchronous or asynchronous operation.

In some embodiments, a REST-based Analytics API provides programmatic access to a report data as defined in the report builder. The API allows a user to integrate the data into any web or mobile application, inside or outside the Salesforce platform. For example, a user might use the API to trigger a Chatter post with a snapshot of top-performing reps each quarter.

In certain implementations, an Analytics API may be used for:
Integrating report data into custom objects.
Defining rich visualizations on top of the API to animate the data.
Building custom dashboards.
Automating custom reporting tasks.

At a high level, the Analytics API resources allow a user to query and filter report data. In certain implementations a user can provide instructions through the Analytics API to:
Run tabular, summary, or matrix reports synchronously or asynchronously.
Filter for specific data on the fly.
Query report metadata.

In some embodiments, the Analytics API may be available for any organization that has API enabled. In an implementation, an authenticated session using OAuth (an open standard for authorization) or other authentication may be required in order to access the Analytics API.

In some embodiments, the Analytics API is operable to:
Run Reports Synchronously or Asynchronously—A report may be run synchronously or asynchronously to obtain summary data with or without details. For example, it may be recommended that a user run reports asynchronously to avoid report timeouts and other API limits.
Obtain Report Metadata—In some embodiments, report metadata provides information regarding a report and its report time. In some embodiments, the report metadata includes information about fields used for report groupings, summaries, detailed data, and filters.
List Asynchronous Runs of a Report—Obtain a list of all instances of a report run asynchronously.
Filter Reports on Demand—Obtain specific data back by running a report with filter changes in the metadata.
List Recently Viewed Reports—Obtain most recently viewed reports that the user has permission to access.

In some embodiments, summary data with or without details may be obtained by running a report synchronously or asynchronously through the Analytics API. When a user runs a report, the Analytics API may, for example, return data for the same number of records that are available when the report is run in the Salesforce user interface.

For example, a user may choose to run a report synchronously if the user expects the report to finish running quickly. Otherwise, it may be recommended that user run reports through the API asynchronously for reasons such as:
Long running reports have a lower risk of reaching the timeout limit when run asynchronously.
An overall time limit, such as a 2-minute overall Salesforce API timeout limit, may not apply to asynchronous runs.
The Analytics API may be able to handle a higher number of asynchronous run requests at a time.
The reports may be available for recurring access. In an example in which results of asynchronously run reports are stored for a 24-hr rolling period, such reports may be available for recurring access during such period.

In some embodiments, a process for running a report synchronously may include:

(1) A GET or POST request to the Execute Sync resource to obtain data.

(2) A POST request to obtain specific results on the fly by passing filters in the report metadata.

In some embodiments, a process for fetching report data asynchronously may include:

(1) A POST request to the Execute Async resource. If passing filters, such filters may be included in the POST request metadata. The request returns the instance ID where results of the run are stored.

(2) A GET request to the Instance Results resource to fetch data using the instance ID.

In some embodiments, report metadata provides information about a report and its report type. The report metadata includes information on fields used in the report for filters, groupings, detailed data, and summaries. The metadata may be utilized for multiple purposes, including:
Identifying what fields in a report type can be filtered on and by what values.
Building custom chart visualizations using the metadata information on fields, groupings, detailed data, and summaries.
Changing filters in the report metadata during a report run.

In order to obtain report metadata, a GET request may be sent to a Describe resource.

In some embodiments, a certain number of instances of a report for which there is requested asynchronous runs may be obtained by sending a GET request to an Instances List resource. The instance list may be sorted by the date when the run was requested. In a particular implementation, report results are stored for a rolling 24-hour period. During this time, based on the user access level, a user may access results for each instance of the report that was run.

In some embodiments, to obtain specific results on the fly, reports may be filtered through the Analytics API. In an implementation, filter changes made through the API do not affect the source report definition. Using the API, filtering may be performed with, for example, up to a certain number custom field filters and add filter logic (such as AND, OR).

Prior to filtering a report, a user may check properties in the metadata that inform the user if a field can be filtered, the values and criteria that may by which filtering may be performed, and identification of filters that already exist in the report. The properties in the metadata may be:
filterable
filterValues
dataTypeFilterOperatorMap
reportFilters

In some embodiments, reports may be filtered during synchronous or asynchronous report runs by making a POST request to the Execute Sync or Execute Async resource.

In a particular example:

In a POST request, an accounts report is filtered synchronously by these passing filters with filter logic in the metadata to the Execute Sync resource, where:

1. Account Name not equal to Data Mart

2. Account Owner not equal to Admin User

3. Annual Revenue greater than “100,000”

4. Industry not equal to Manufacturing, Recreation

Filter logic: (1 OR 4) AND 2 AND 3.

In some embodiments, each report listing in the response has resource URLs to obtain metadata and to run a report asynchronously or synchronously. For a more extensive reports list, the Report object may be queried using a SOQL query in a Salesforce API such as SOAP API or REST API. This SOQL query, for example, returns all reports that are in matrix format: SELECT Description, Format, LastRunDate FROM Report WHERE Format=‘MATRIX’ ORDER BY Id ASC NULLS FIRST

In some embodiments, depending on the report run that is requested from the Execute Sync or Execute Async resources, a fact map in the report results can contain values for only summary or both summary and detailed data. The fact map values are expressed as keys, which can be programmatically used to visualize the report data.

It is noted that the examples presented here are intended to sufficiently illustrate the technology disclosed without being overly complicated. Such examples are not intended to illustrate all of the technologies disclosed. A person having ordinary skill in the art may appreciate that there are many potential applications for one or more implementations of this disclosure and hence, the implementations disclosed herein are not intended to limit this disclosure in any fashion.

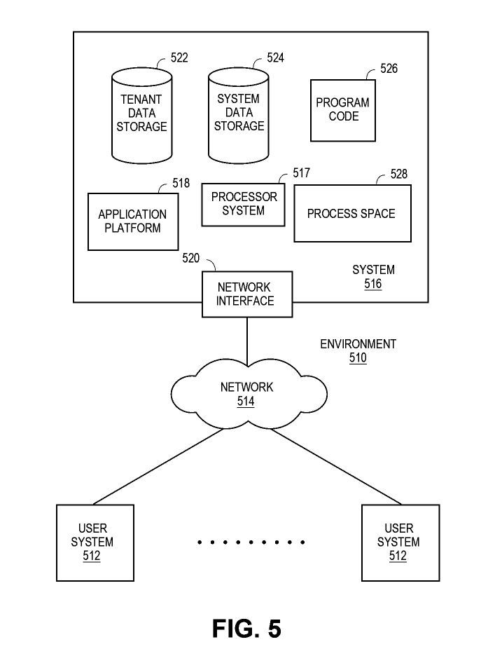

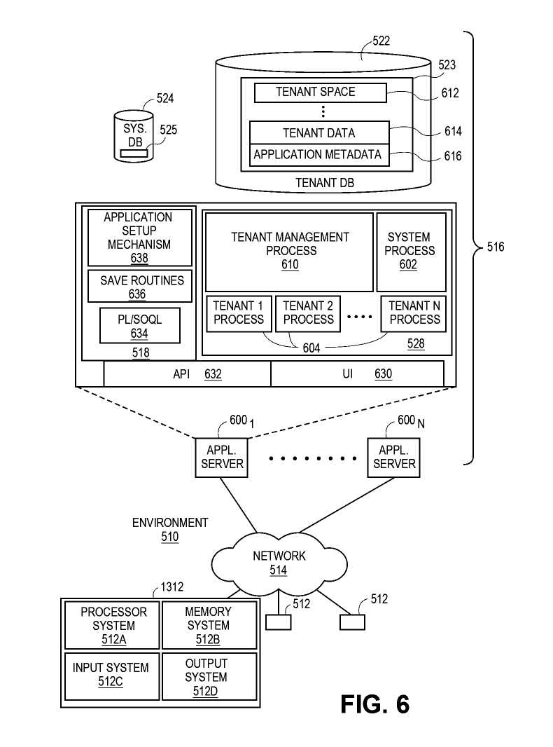

FIG. 5 illustrates a block diagram of an environment according to an embodiment, and FIG. 6 illustrates details of an environment according to an embodiment. Components within an environment 510 may belong to different layers (e.g., compute, management) and may communicate as described above. Environment 510 may include user systems 512, network 514, system 516, processor system 517, application platform 518, network interface 520, tenant data storage 522, system data storage 524, program code 526, and process space 528. In other embodiments, environment 510 may not have all of the components listed and/or may have other elements instead of, or in addition to, those listed above.

Environment 510 is an environment in which an on-demand database service exists. User system 512 may be any machine or system that is used by a user to access a database user system. For example, any of user systems 512 can be a handheld computing device, a mobile phone, a laptop computer, a workstation, and/or a network of computing devices. As illustrated in FIG. 5, and in more detail in FIG. 6, user systems 512 might interact via a network 514 with an on-demand database service, which is system 516.

An on-demand database service, such as system 516, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 516” and “system 516” will be used interchangeably herein.

A database image may include one or more database objects. A relational database management system (RDMS) or the equivalent may execute storage and retrieval of information against the database object(s). Application platform 518 may be a framework that allows the applications of system 516 to run, such as the hardware and/or software, e.g., the operating system. In an embodiment, on-demand database service 516 may include an application platform 518 that enables creation, managing and executing one or more applications developed by the provider of the on-demand database service, users accessing the on-demand database service via user systems 512, or third party application developers accessing the on-demand database service via user systems 512.

The users of user systems 512 may differ in their respective capacities, and the capacity of a particular user system 512 might be entirely determined by permissions (permission levels) for the current user. For example, where a salesperson is using a particular user system 512 to interact with system 516, that user system has the capacities allotted to that salesperson. However, while an administrator is using that user system to interact with system 516, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level. Network 514 is any network or combination of networks of devices that communicate with one another. For example, network 514 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the Internet, that network will be used in many of the examples herein. However, it should be understood that the networks that are used in one or more implementations may not be so limited, although TCP/IP is a frequently implemented protocol.

User systems 512 might communicate with system 516 using TCP/IP and, at a higher network level, use other common Internet protocols to communicate, such as HTTP, FTP, AFS, WAP, etc. In an example where HTTP is used, user system 512 might include an HTTP client commonly referred to as a “browser” for sending and receiving HTTP messages to and from an HTTP server at system 516. Such an HTTP server might be implemented as the sole network interface between system 516 and network 514, but other techniques might be used as well or instead. In some implementations, the interface between system 516 and network 514 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 516, shown in FIG. 5, implements a web-based customer relationship management (CRM) system. For example, in one embodiment, system 516 includes application servers configured to implement and execute CRM software applications as well as provide related data, code, forms, webpages and other information to and from user systems 512 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 516 implements applications other than, or in addition to, a CRM application. For example, system 516 may provide tenant access to multiple hosted (standard and custom) applications, including a CRM application. User (or third party developer) applications, which may or may not include CRM, may be supported by the application platform 518, which manages creation, storage of the applications into one or more database objects and executing of the applications in a virtual machine in the process space of the system 516.

One arrangement for elements of system 516 is shown in FIG. 5, including a network interface 520, application platform 518, tenant data storage 522 for tenant data 523, system data storage 524 for system data 525 accessible to system 516 and possibly multiple tenants, program code 526 for implementing various functions of system 516, and a process space 528 for executing MTS system processes and tenant-specific processes, such as running applications as part of an application hosting service. Additional processes that may execute on system 516 include database indexing processes.

Several elements in the system shown in FIG. 5 include conventional, well-known elements that are explained only briefly here. For example, each user system 512 could include a desktop personal computer, workstation, laptop or notebook, tablet computer, smart phone, cell phone, or any wireless access protocol (WAP) enabled device or any other computing device capable of interfacing directly or indirectly to the Internet or other network connection. User system 512 typically runs an HTTP client, e.g., a browsing program, such as Microsoft's Internet Explorer, Firefox, Chrome, or a mobile operating system browser in the case of a smart phone, cellular phone, or other wireless device, or the like, allowing a user (e.g., subscriber of the multi-tenant database system) of user system 512 to access, process and view information, pages and applications available to it from system 516 over network 514. Each user system 512 also typically includes one or more user interface devices, such as a keyboard, a mouse, trackball, touch pad, touch screen, pen, gesture recognition, or the like, for interacting with a graphical user interface (GUI) provided by the browser on a display (e.g., a monitor screen, LCD display, etc.) in conjunction with pages, forms, applications and other information provided by system 516 or other systems or servers. For example, the user interface device can be used to access data and applications hosted by system 516, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 512 and all of its components are operator configurable using applications, such as a browser, including computer code run using a central processing unit such as an Intel processor, including Celeron®, Pentium®, Core®, and Xeon® processors, or the like. Similarly, system 516 (and additional instances of an MTS, where more than one is present) and all of their components might be operator configurable using application(s) including computer code to run using a central processing unit such as processor system 517, which may include an Intel processor or the like, and/or multiple processor units.

A computer program product embodiment includes a machine-readable storage medium (media), including non-transitory computer-readable storage media, having instructions stored thereon/in which can be used to program a computer to perform any of the processes of the embodiments described herein. Computer code for operating and configuring system 516 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 516 is configured to provide webpages, forms, applications, data and media content to user (client) systems 512 to support the access by user systems 512 as tenants of system 516. As such, system 516 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 6 also illustrates environment 510. However, in FIG. 6 elements of system 516 and various interconnections in an embodiment are further illustrated. FIG. 6 shows that user system 512 may include processor system 512A, memory system 512B, input system 512C, and output system 512D. FIG. 6 shows network 514 and system 516. FIG. 6 also shows that system 516 may include tenant data storage 522, tenant data 523, system data storage 524, system data 525, User Interface (UI) 630, Application Program Interface (API) 632, PL/SOQL 634, save routines 636, application setup mechanism 638, applications servers 600₁-600_{N}, system process space 602, tenant process spaces 604, tenant management process space 610, tenant storage space 612, tenant data 614, and application metadata 616. In other embodiments, environment 510 may not have the same elements as those listed above and/or may have other elements instead of, or in addition to, those listed above.

User system 512, network 514, system 516, tenant data storage 522, and system data storage 524 were discussed above in FIG. 5. Regarding user system 512, processor system 512A may be any combination of one or more processors. Memory system 512B may be any combination of one or more memory devices, short term, and/or long term memory. Input system 512C may be any combination of input devices, such as one or more keyboards, mice, trackballs, scanners, cameras, and/or interfaces to networks. Output system 512D may be any combination of output devices, such as one or more monitors, printers, and/or interfaces to networks. As shown by FIG. 6, system 516 may include a network interface 520 (illustrated in FIG. 5) implemented as a set of HTTP application servers 600, an application platform 518, tenant data storage 522, and system data storage 524.

Also shown in FIG. 6 is system process space 602, including individual tenant process spaces 604 and a tenant management process space 610. Each application server 600 may be configured to tenant data storage 522 and the tenant data 523 therein, and system data storage 524 and the system data 525 therein to serve requests of user systems 512. The tenant data 523 might be divided into individual tenant storage spaces 612, which can be either a physical arrangement and/or a logical arrangement of data. Within each tenant storage space 612, tenant data 614 and application metadata 616 might be similarly allocated for each user. For example, a copy of a user's most recently used (MRU) items might be stored to tenant data 614. Similarly, a copy of MRU items for an entire organization that is a tenant might be stored to tenant storage space 612. A UI 630 provides a user interface and an API 632 provides an application programmer interface to system 516 resident processes to users and/or developers at user systems 512. The tenant data and the system data may be stored in various databases, such as one or more Oracle™ databases.

Application platform 518 includes an application setup mechanism 638 that supports application developers' creation and management of applications, which may be saved as metadata into tenant data storage 522 by save routines 636 for execution by subscribers as one or more tenant process spaces 604 managed by tenant management process 610 for example. Invocations to such applications may be coded using PL/SOQL 634 that provides a programming language style interface extension to API 632. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 616 for the subscriber making the invocation and executing the metadata as an application in a virtual machine.

Each application server 600 may be communicably coupled to database systems, e.g., having access to system data 525 and tenant data 523, via a different network connection. For example, one application server 600₁ might be coupled via the network 514 (e.g., the Internet), another application server 600_{N-1} might be coupled via a direct network link, and another application server 600_{N} might be coupled by yet a different network connection. Transfer Control Protocol and Internet Protocol (TCP/IP) are typical protocols for communicating between application servers 600 and the database system. However, it will be apparent to one skilled in the art that other transport protocols may be used to optimize the system depending on the network interconnect used.

In certain embodiments, each application server 600 is configured to handle requests for any user associated with any organization that is a tenant. Because it is desirable to be able to add and remove application servers from the server pool at any time for any reason, there is preferably no server affinity for a user and/or organization to a specific application server 600. In one embodiment, therefore, an interface system implementing a load balancing function (e.g., an F5 Big-IP load balancer) is communicably coupled between the application servers 600 and the user systems 512 to distribute requests to the application servers 600. In one embodiment, the load balancer uses a least connections algorithm to route user requests to the application servers 600. Other examples of load balancing algorithms, such as round robin and observed response time, also can be used. For example, in certain embodiments, three consecutive requests from the same user could hit three different application servers 600, and three requests from different users could hit the same application server 600. In this manner, system 516 is multi-tenant, wherein system 516 handles storage of, and access to, different objects, data and applications across disparate users and organizations.

As an example of storage, one tenant might be a company that employs a sales force where each salesperson uses system 516 to manage their sales process. Thus, a user might maintain contact data, leads data, customer follow-up data, performance data, goals and progress data, etc., all applicable to that user's personal sales process (e.g., in tenant data storage 522). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 516 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 516 might also maintain system level data usable by multiple tenants or other data. Such system level data might include industry reports, news, postings, and the like that are sharable among tenants.

In certain embodiments, user systems 512 (which may be client systems) communicate with application servers 600 to request and update system-level and tenant-level data from system 516 that may require sending one or more queries to tenant data storage 522 and/or system data storage 524. System 516 (e.g., an application server 600 in system 516) automatically generates one or more SQL statements (e.g., one or more SQL queries) that are designed to access the desired information. System data storage 524 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers. Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

While concepts been described in terms of several embodiments, those skilled in the art will recognize that embodiments not limited to the embodiments described, but can be practiced with modification and alteration within the spirit and scope of the appended claims.

The description is thus to be regarded as illustrative instead of limiting.

What is claimed is:

1. A method comprising:
receiving a request at a database system from a user to embed a representation of analytics data on a first page;
generating by a processing unit of the database system an embed area in the page in which to display the analytics data on the page;
storing in a memory of the database system metadata associated with the page describing the embed area; and
upon the database system detecting an access to the first page, automatically generating by the database system the first page with the analytics data located in the embed area based upon the metadata.

2. The method of claim 1, wherein generating the page includes retrieval of analytics data and record data from a database of the database system.

3. The method of claim 1, wherein generating the page includes generating a chart based on the analytics data.

4. The method of claim 1, further comprising generating a change notification when data for the analytics has changed.

5. The method of claim 1, further comprising embedding the same analytics data in a second page.

6. A method comprising:
receiving a request to generate an analytics report through an analytics application programming interface (API) for a database system; and
in response to the request, rendering by a processing unit of the database system analytics data for display on a page, including:
establishing calls to underlying data stored in a data store for the analytics report, and
serializing the analytics data for display on a page;
wherein rendering of the data by the database system may utilize either synchronous or asynchronous operation.

7. The method of claim 6, wherein a determination by the database system of synchronous or asynchronous operation is based on the request from the user.

8. The method of claim 6, wherein a determination by the database system of synchronous or asynchronous operation is generated based on resource constraints.

9. The method of claim 6, wherein the rendering of the analytic data includes:
retrieving data to be analyzed from a first data store;
retrieving data to be analyzed from a second data store;
generating combined data from the first data store and the second data store; and
displaying the combined data.

10. The method of claim 9, wherein displaying the combined data includes either displaying the data from the first data store and the second data store in a same manner as data from a single data store or displaying the data from the first data source and the second data source separately.

11. The method of claim 6, further comprising establishing a data alert to be triggered when a certain threshold is met or exceeded.

12. A database system comprising:
an interface to receive from a user a request to embed a representation of analytics data on a first page;
a processing unit to process data, including generating an embed area in the page in which to display the analytics data on the page; and
a memory for storage of data, the processing unit to store in the memory metadata associated with the page describing the embed area;
wherein, upon the database system detecting an access to the first page, automatically generating by the processing unit the first page with the analytics data located in the embed area based upon the metadata.

13. The system of claim 12, wherein generating the page includes the processing unit to retrieve analytics data and record data from a database of the database system.

14. The system of claim 12, wherein generating the page includes automatically generating a chart based on the analytics data.

15. The system of claim 12, wherein the processing unit is further to automatically generate a change notification when data for the analytics has changed.

16. A database system comprising:
an interface to receive a request to generate an analytics report, the request being received through an analytics application programming interface (API) for the database system;
a data store to store data;
a processing unit to process data, the processing unit, in response to the request, to rendering analytics data for display on a page, including the processing unit to:
establish calls to underlying data stored in the data store for the analytics report, and
serialize the analytics data for display on a page;
wherein rendering of the data by the processing unit may be either a synchronous operation or an asynchronous operation.

17. The system of claim 16, wherein a determination by the database system of synchronous or asynchronous operation is based on the request from the user.

18. The system of claim 16, wherein a determination by the database system of synchronous or asynchronous operation is generated based on resource constraints.

19. The system of claim 16, wherein the rendering of the analytic data includes the processing unit to automatically:
retrieve data to be analyzed from a first data store;
retrieve data to be analyzed from a second data store;
generate combined data from the first data store and the second data store; and
display the combined data.

20. The system of claim 19, wherein displaying the combined data includes either displaying the data from the first data store and the second data store in a same manner as data from a single data store or displaying the data from the first data source and the second data source separately.

21. The system of claim 16, wherein the processing unit is further to establish a data alert to be triggered when a certain threshold is met or exceeded.

22. A non-transitory computer-readable storage medium having stored thereon data representing sequences of instructions that, when executed by a processor, cause the processor to perform operations comprising:
receiving a request at a database system from a user to embed a representation of analytics data on a first page;
generating by a processing unit of the database system an embed area in the page in which to display the analytics data on the page;
storing in a memory of the database system metadata associated with the page describing the embed area; and
upon the database system detecting an access to the first page, automatically generating by the database system the first page with the analytics data located in the embed area based upon the metadata.

23. The medium of claim 22, wherein generating the page includes retrieval of analytics data and record data from a database of the database system.

24. The medium of claim 22, wherein generating the page includes generating a chart based on the analytics data.

25. A non-transitory computer-readable storage medium having stored thereon data representing sequences of instructions that, when executed by a processor, cause the processor to perform operations comprising:
receiving a request to generate an analytics report through an analytics application programming interface (API) for a database system; and
in response to the request, rendering by a processing unit of the database system analytics data for display on a page, including:
establishing calls to underlying data stored in a data store for the analytics report, and
serializing the analytics data for display on a page;
wherein rendering of the data by the database system may utilize either synchronous or asynchronous operation.

26. The medium of claim 25, wherein a determination by the database system of synchronous or asynchronous operation is based on the request from the user.

27. The medium of claim 25, wherein a determination by the database system of synchronous or asynchronous operation is generated based on resource constraints.
